(19) United States
(12) Patent Application Publication
(10) Pub. No.: US 2022/0242072 A1
(43) Pub. Date: Aug. 4, 2022

(54) APPARATUS AND PROCESS FOR SEALING OF GAPS IN PARTS MANUFACTURED VIA 3D PRINTING TECHNIQUES

(71) Applicant: Essentium, Inc., Pflugerville, TX (US)

(72) Inventors: Nirup Nagabandi, Pflugerville, TX (US); Kevin Michael Holder, Pflugerville, TX (US); Luke Johnson, Pflugerville, TX (US); Elisa Teipel, Pflugerville, TX (US)

(21) Appl. No.: 17/626,316

(22) PCT Filed: Jul. 10, 2020
(86) PCT No.: PCT/US2020/041504

§ 371 Date: Jan. 11, 2022

Related U.S. Application Data
(60) Provisional application No. 62/873,519, filed on Jul. 12, 2019.

(51) Int. Cl. B29C 71/00; B29C 64/30

(52) U.S. Cl. CPC B29C 71/009; B33Y 40/20; B29C 64/30

(57) ABSTRACT

A method for sealing gaps in a component including generating vapor from a liquid; directing the vapor to an exposed surface of the component, wherein the component includes a plurality of layers of an extrudate and gaps between the plurality of layers and wherein the extrudate includes an outer portion; softening the outer portion of the extrudate at the exposed surface; and filling the gaps with softened outer portion of the extrudate. An apparatus includes a heating chamber including at least one first heating element; a vapor chamber coupled to the heating chamber; a pressure regulator operatively coupled to the vapor chamber; and a nozzle coupled to the vapor chamber by a duct.

### CROSS-REFERENCE TO RELATED APPLICATIONS

This application claims the benefit of U.S. Provisional Application No. 62/873,519, filed Jul. 12, 2019, the teachings of which are incorporated by reference.

### FIELD

The present disclosure is directed to an apparatus and process for sealing of gaps in parts manufactured via 3D printing techniques including extrusion based additive manufacturing techniques.

### BACKGROUND

3D printing techniques are processes for forming three-dimensional objects by adding material layer by layer to build objects. 3D printing techniques include, for example, extrusion based additive manufacturing processes such as fused filament fabrication. These techniques allow for the relatively rapid fabrication of parts without having to wait for the development of tooling and the associated costs of tooling. However, extrusion based additive manufacturing processes may also produce parts that exhibit pores, gaps, ridges, and other surface defects, particularly between the layers used to form the object. While the parts may be sealed by epoxy resins, which are often reacted with or without a co-reactant to form a thermosetting polymer, there may be some disadvantages associated with epoxy resins, including material compatibility and the solvent systems that epoxies are often carried in. Techniques to smooth additive manufactured surfaces with vapor exist; however, it is not understood that directed and controlled flow is provided for sealing channels and processes for control and checking water-tight quality does not exist.

Thus, while current 3D printing techniques achieve their intended purpose, there is a need for an apparatus and process that seals the gaps in 3D printed components to make such 3D printed parts useful in water-tight and air-tight applications. The apparatus and process should provide 3D printed components of relatively higher quality that may be water-tight and air-tight.

### SUMMARY

According to several aspects, the present disclosure relates to a method of sealing gaps in a component. The method includes generating a vapor from a liquid and directing the vapor to an exposed surface of a component. The component includes a plurality of layers of an extrudate and gaps between the plurality of layers and wherein the extrudate includes an outer portion. The method further includes softening the outer portion of the extrudate at the exposed surface; and filling the gaps with the softened outer portion of the extrudate.

In additional aspects, the exposed surface is a channel defined within the component.

In additional aspects, the component is a tool and the channel is a cooling line.

In further aspects, the extrudate has a glass transition temperature and the method further comprises adjusting at least one of a vapor temperature and vapor pressure to raise the outer portion of the extrudate to a temperature greater than the glass transition temperature of the extrudate.

In further aspects, the extrudate includes an outer surface and the outer portion is up to 10% of a thickness of the extrudate from the outer surface.

In additional aspects, the outer portion of the extrudate includes a sheath having a lower glass transition temperature than a glass transition temperature of a core of the extrudate surrounded by the sheath.

In further aspects, directing the vapor comprises inducing a laminate flow.

In yet further aspects, directing the vapor comprises inducing a swirling or turbulent flow.

In additional aspects, the liquid is an organic alcohol.

In additional aspects, the liquid is a weak acid.

In additional aspects, the liquid is water.

According to several aspects, the present disclosure relates to an apparatus for sealing gaps in a 3D component. The apparatus includes a heating chamber including at least one first heating element. The apparatus further includes a vapor chamber coupled to the heating chamber and a pressure regulator operatively coupled to the vapor chamber. The apparatus yet further includes a nozzle coupled to the vapor chamber by a duct.

In further aspects, the nozzle is located within a 3D printer.

In additional aspects, the apparatus further includes at least one thermocouple operatively coupled to the heating chamber.

In additional aspects, the apparatus further includes at least one second heating element.

In additional aspects, the apparatus further includes at least one second thermocouple associated with the vapor chamber.

In further aspects, the at least one first heating element is located within the heating chamber.

In additional aspects, the apparatus further incudes a bladder located in the vapor chamber.

In additional aspects, the further including a plurality of nozzles.

According to several aspects, the present disclosure is directed to a tool. The tool includes a component including extrudate arranged in layers, wherein the component includes exposed surfaces; a cavity defined by a first exposed surface; a cooling line defined by a second exposed surface; and a plurality of gaps between the layers, wherein the gaps between the layers at the second exposed surface are sealed with a portion of the extrudate.

According to several aspects, the present disclosure is directed to a method of making a tool. The method includes connecting a component to one or more support plates. The component including an extrudate arranged in layers, wherein the component includes exposed surfaces, a cavity defined by a first exposed surface, a cooling line defined by a second exposed surface, and a plurality of gaps between the layers, wherein the gaps between the layers at the second exposed surface are sealed with a portion of the extrudate. In aspects, the component is formed by fused filament fabrication and gaps in the component are sealed according to the methods noted above.

### BRIEF DESCRIPTION OF THE FIGURES

The drawings described herein are for illustration purposes only and are not intended to limit the scope of the present disclosure in any way.

FIG. 1A is a perspective view of a 3D printed component of the present disclosure according to an exemplary embodiment;

FIG. 1B is a close-up of a perspective view of a wall section of the 3D printed component of FIG. 1A according to an exemplary embodiment;

FIG. 1C is a close-up of the wall section of FIG. 1B according to an exemplary embodiment;

FIG. 2A is a front view of an example of a 3D printed component of the present disclosure, wherein the shading illustrates an example of an extrudate pattern according to an exemplary embodiment;

FIG. 2B illustrates a top view of the 3D printed component of FIG. 2A, wherein the shading illustrates the extrudate pattern according to an exemplary embodiment;

FIG. 2C is a side view of the 3D printed component of FIG. 2A, wherein the shading illustrates the extrudate pattern according to an exemplary embodiment;

FIG. 2D is a cross-section of the top view of the 3D printed component of FIG. 2A, wherein the shading illustrates the extrudate pattern according to an exemplary embodiment;

FIG. 3 illustrates a schematic of an apparatus for sealing a 3D printed component with vapor according to an exemplary embodiment;

FIG. 4 illustrates a flow diagram of a method of sealing the gaps of a 3D printed component according to an exemplary embodiment;

FIG. 5A illustrates a cross-section of a 3D printed component of FIG. 2A including a channel defined therein through which vapor may be passed according to an exemplary embodiment;

FIG. 5B illustrates a close-up 40 taken in FIG. 5A, wherein the close-up illustrates the vapor flowing in the same direction as the extrudate flow according to an exemplary embodiment;

FIG. 5C illustrates a close-up 40′ taken in FIG. 5C, wherein the close-up illustrates the vapor flowing perpendicular to the direction of extrudate flow according to an exemplary embodiment;

FIG. 6A illustrates a 3D printed component for use as a tool, or part of a tool, including a cavity and cooling lines according to an exemplary embodiment; and

FIG. 6B illustrates a 3D printed component retained in the opening of a tool according to an exemplary embodiment.

### DETAILED DESCRIPTION

The following description is merely exemplary in nature and is not intended to limit the present disclosure, application, or uses.

The present disclosure is directed to an apparatus and process that seals gaps in 3D printed components and in aspects the 3D printed components include those formed by extrusion based additive manufacturing processes such as fused deposition modeling or fused filament fabrication. Gaps include openings and pores of various size present between layers or within a single layer. Further, the apparatus and process may allow for the provision of water-tight or air-tight features in a 3D printed object.

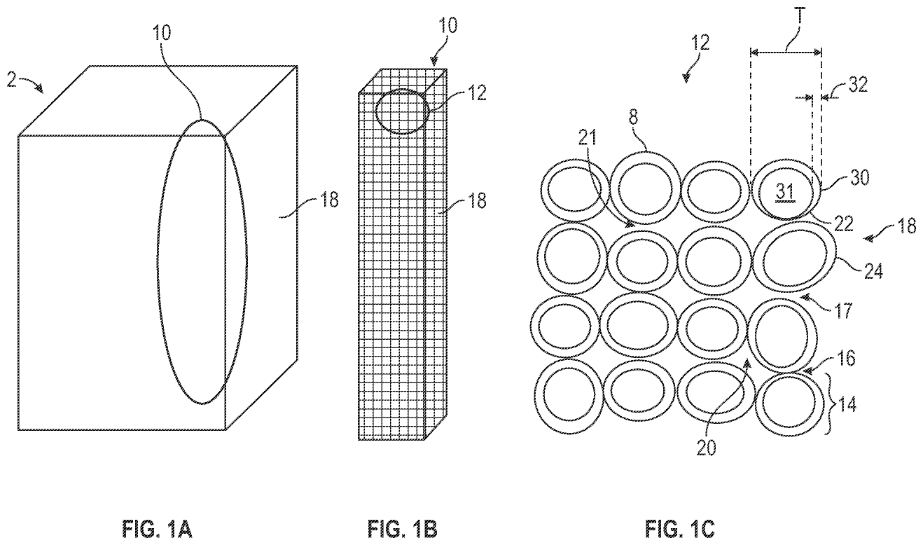

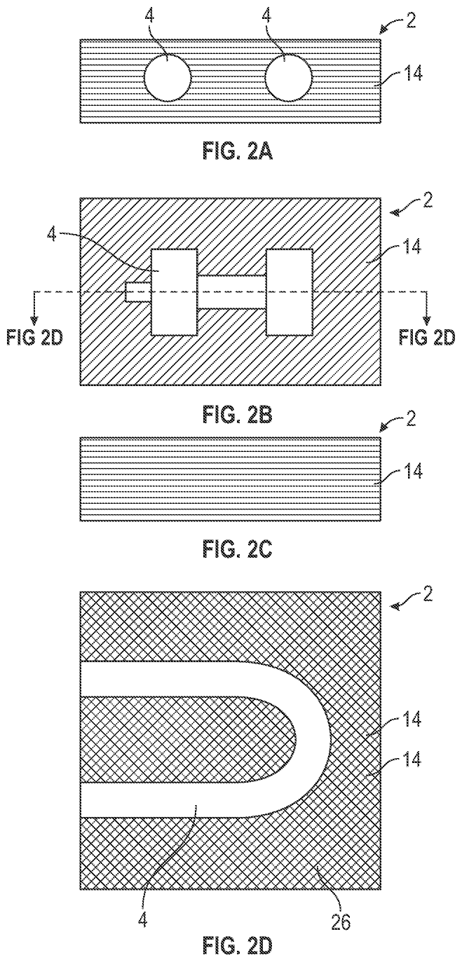

FIG. 1A illustrates an example of a 3D printed component 2 including a wall section 10. FIG. 1B illustrates a close-up of the wall section 10 of a 3D printed component 2 in accordance with an aspect of the present disclosure. FIG. 1C illustrates a close-up 12 of the wall section of FIG. 1B. The wall section 10 includes extruded material (extrudate 8) arranged in layers 14 and stacked. The extrudate 8 is the material, typically in the form of a filament, that is extruded by the 3D printer to form the 3D printed component 2. Various types of gaps 16, 17, 20, 21 are defined by and between the extruded layers 14 and again include, for example, pores or other spaces between the extrudate 8. Some gaps 16, 20 are created as the generally circular or oblong extrudate do not touch on all sides, and form even where the extrudate is stacked side by side and layer upon layer. Other gaps 17, 21 are interlayer gaps, where two adjoining layers of extrudate do not touch. Interlayer gaps often occur between layers of infill that are laid down at angles to each other, or where there is a geometry change requiring a shift in the printed extrudate. In addition, some of the gaps 16, 17 are present at exposed surfaces 18 of the wall section 10, other gaps 20, 21 are defined in the infill behind the exposed surfaces 18 of the wall section 10. Exposed surfaces 18 may include flow channels or other features formed in the 3D printed component 2. FIGS. 2A through 2D illustrate an arrangement of the layers 14 and exposed surfaces 18 in an exemplary 3D printed component 2 including in a channel 4. In addition, as illustrated, particularly in FIG. 2D, the extruded layers 14 may be placed at angles to each other, wherein a first layer 22 (see FIG. 1B) may be arranged at an angle in the range of 10 to 90 degrees, including all values and ranges therein, relative to a second layer 24, resulting in a cross-hatch appearance, such as the cross-hatch pattern 26 seen in FIG. 2D. Further, exposed surfaces 18 include those surfaces that generally define the shape and contours of the 3D printed component 2 including, e.g., the exterior of the 3D printed component 2 or the channel 4 of the 3D printed component 2.

In aspects, the 3D printed component 2 is formed from an extrudate 8 that includes at least one material possessing a glass transition temperature (T_{g}) and, optionally, in the case of crystalline materials, a melt temperature (Tₘ). Where the material does not have a definite melting point, the Vicat softening temperature may be determined, measured in accordance with ASTM D 1525. In aspects, the material is a thermoplastic material, including but not limited to poly(ethylene terephthalate), polystyrene, acrylonitrile butadiene styrene (ABS), polyethylene (PE), polycarbonate (PC), polyamide (nylon), polyphenylene sulfone (PPSU), polyetherimide, polyether ether ketone (PEEK), polytetrafluoroethylene (PTFE), polylactic acid (PLA), modified formulations thereof, copolymers thereof and combinations thereof. Further, the material may be filled or unfilled with an additive such as nanocellulose, carbon fibers, ferrous particles, etc. In addition, extrudate 8 may be provided by a bi-component, or multi-component filament, wherein more than one material, each selected from, e.g., those noted above, is present in the filament and the filament exhibits a number of geometries such as sheath/core, side by side, segmented pie, island in the sea, striped, multi-lobal, etc.

In further aspects, the extrudate 8 includes additives such as, but not limited to: fibers including carbon fiber, glass fiber, metal fibers, mineral fibers, or fibers of a different polymer having relatively higher melting points than that of the polymer forming the extrudate 8; and particles, powders or flakes including glass, metal, cellulose, mineral, carbon, or carbon nanotubes. In aspects, the additives include electromagnetic susceptible materials that heat upon the application of radio frequency including, for example, ferrous metals or carbon nanotubes in the forms described above. The fibers exhibit a particle size in the range of 1 micrometer to 100 micrometers, including all values and ranges therein and the particles, powders or flakes exhibit a size of 100 micrometers or less including all values and ranges therein, including nanoparticles having a particle length of less than 1.0 micrometer or less, including all values and ranges between 10 nanometers and 1 micrometer. Such additives, in aspects, are dispersed in the extrudate 8 and, in other aspects, are provided in a coating on the extrudate 8 core, wherein the coating includes the same polymer or a different polymer than the extrudate 8 core. The additives are present in the range of 0.1% to 90% of the total weight of the extrudate 8, including all values and ranges therein.

In further aspects, other additives are included, such as pigments, dispersants, surface modifiers, processing aids such as viscosity reducers or release agents, and flame-retardant agents, such as a vinyl modified siloxane, organo-modified siloxanes. These additives are, in aspects, dispersed through the extrudate 8, or, in alternative aspects, localized in either the extrudate 8 core or extrudate 8 coating. The additives are present in the range of 0.1 to 25% of the total weight of the extrudate 8, including all values and ranges therein.

When the 3D printed component 2 is exposed to vapor, such as steam, and the vapor provides sufficient heat to raise the temperature of the exposed surfaces 18 of the extrudate 8 to a temperature at or above the glass transition temperature (Tg) of the extrudate 8 material, or at least a portion thereof in the case of bi- or multi-component material, the extrudate 8 softens and becomes deformable and in-part flowable/movable. It may be appreciated, however, that as the printed material is exposed to vapor, a temperature gradient may be present between the outer surface 30 of the extrudate 8 material and the material core 31.

An example of such a temperature gradient is illustrated in FIG. 1C, where an outer portion 32 of the extrudate 8, from the outer surface 30 of the extrudate 8 and up to 10% of the extrudate 8 thickness T from the outer surface 30 in depth, transitions past the glass transition temperature, and in aspects transitions past the melting temperature, of the material including all values and ranges from 0.1% of the thickness to 10% of the extrudate 8 thickness. As may be appreciated, in the case of bi-component or multi-component extrudate 8, the outer portion 32 of the extrudate 8 may be configured to be formed from the same material or a different material than the remainder of the extrudate 8. In some cases, the outer portion 32 of the extrudate may be configured to be formed from the same base material that has been modified with various additives or fillers selected based on the application. In other aspects, the outer portion 32 of the extrudate includes a heat sensitive adhesive material that is activated, or caused to flow, upon exposure to the vapor. Examples of such heat sensitive adhesive materials include EVA, polyamides, polyesters, styrene block copolymers, polyethylene, ethylene-methyl acrylate or ethylene butyl acrylate.

In aspects, various attributes of the vapor, discussed further herein, are adjusted to prevent the entire thickness T of the extrudate 8, the core in the case of sheath-core extrudate 8, or greater than 10% of the thickness T of the extrudate 8, from passing into the molten stage from the softening phase. It may be appreciated that keeping the printed layers 14 from softening completely may prevent the 3D printed component 2 from losing its structural integrity.

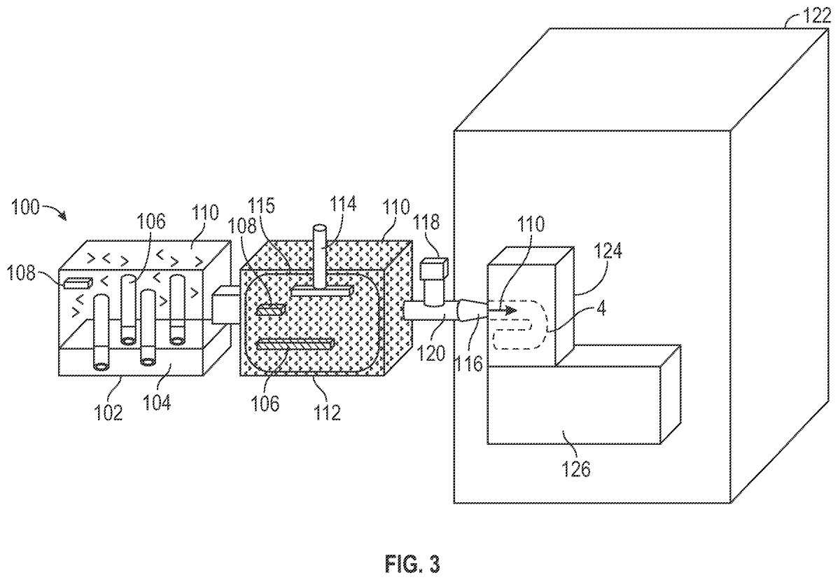

It may further be appreciated that vapor 110 (illustrated in FIG. 3) carries different energies based on the temperature and pressure it is operated, generated, or stored at. The variable energy of vapor 110 may be used to seal gaps 16, 17 on multiple materials with a single process and to control and flow of the vapor 110 into the spaces of the 3D printed component, unlocking the ability to seal the exposed surfaces 18 of internal channels 4 and features of the 3D printed component 2. Further, in aspects, the direction of flow is directed through the channels 4 at various angles to the extrudate 8 layers 14, including an angle in the range of parallel to a plane P defined by the extrudate 8 layers 14 (as illustrated in FIG. 5B), perpendicular a plane P defined by the extrudate 8 layers 14 (as illustrated in FIG. 5C), or any angle in between. It should be appreciated that in various aspects the vapor 110 includes steam formed from water. In additional or alternative aspects any liquid 104 that can be converted into vapor 110 may be utilized herein in addition to or alternatively to water, such as an organic alcohol, ketones, oils, or weak acids, wherein the liquids exhibit a pKa of 1.0 or greater and, preferably 2.0 or greater. Organic alcohols include one or more hydroxyl groups attached to single bonded alkanes. In aspects, the organic alcohols include from 1 to 10 carbon atoms in the alkane and, in preferred aspects, include ethyl alcohol iso-propyl alcohol, and glycerol. In further aspects, the liquids include hydroxyl-modified compounds such as ethylene glycol and polyethylene glycol. In yet further aspects, the liquids include ketones such as acetone and acetylacetone. In additional aspects, the liquids include oils such as mineral oils or other oils that include 9 or more carbon atoms and remains liquid at temperatures of up to 150° C., such as in the range of 18° C. to 150° C. In yet further aspects, the liquids include a weak acid having a pKa of 1.0 or greater and, in aspects, preferably greater than 2.0. Such weak acids include citric acid, hydrofluoric acid, acetic acid, formic acid, phosphoric acid, oxalic acid, and benzoic acid. Various attributes of the vapor 110, including temperature, pressure, mass, mass or volumetric flow rate, flow direction, etc., may be selected to control the flow and seal the gaps 16, 17 formed during the extrusion based additive manufacturing process.

With reference to FIG. 3, an aspect of an apparatus is provided herewith that generates vapor 110 from water, or other liquid 104, and pumps the vapor 110 onto or into a 3D printed component 2. The apparatus 100 includes a heating chamber 102. Water or other liquid 104 is held in the heating chamber 102. At least one first heating element 106, such as a tubular heater, is associated with the heating chamber 102. As illustrated the heating elements 106 are located within the heating chamber 102 and submerged in the liquid 104. Four tubular heaters are illustrated; it may be appreciated, however, that, e.g., in the range of 1 to 20 heaters may be present. In addition, or alternatively, the heating elements 106 may be placed outside of the heating chamber 102 and may include other radiant heating elements such as heater bands that heat the heating chamber 102, inductive heating elements that radiantly heats the liquid 104, or a dielectric heating element that heats the liquid 104 by electromagnetic radiation, such as microwave electromagnetic irradiation or radio frequency radiation. The liquid 104 is heated to the vapor phase to generate vapor 110. In aspects, the heating chamber 102 includes one or more first thermocouples 108 operatively coupled thereto for measuring the temperature of the vapor 110 within the heating chamber 102 either directly or indirectly through measurement of the liquid 104, the heating chamber 102, or both liquid 104 and the heating chamber 102.

It is contemplated that the vapor 110 is then communicated to a vapor chamber 112 coupled to the heating chamber 102. In aspects, a one-way valve allows vapor 110, and in further aspects only vapor 110, to flow from the heating chamber 102 to the vapor chamber 112. The vapor chamber 112 stores the vapor 110 prior to use and monitors and preconditions the vapor pressure to desired pressure for the application. Adjustment and maintenance of vapor pressure provides control of the heat given out to the printed object to keep the melting of the part within 10% thickness of the outer surface. It is understood that vapor temperature and pressure both need to be regulated to supply the 3D printed component with the heat required. In aspects, the vapor chamber 112 is insulated to prevent a drop in the temperature and condensation of liquid from the vapor phase. In additional aspects, the vapor chamber 112 includes a pressure regulator 114, which is used to regulate the pressure of the vapor 110 in the vapor chamber 112. The pressure regulator 114 is operatively coupled to the vapor chamber 112, such that pressure of the vapor 110 can be measured and, in aspects, also adjusted. For example, in aspects, the pressure regulator 114 is a relief valve and releases vapor from the vapor chamber 112 at a valve set point. In further aspects, a pneumatic or mechanical bladder 115 or other volumetric adjustment device, such as a piston, is located within the vapor chamber 112 that alters the volume of the vapor chamber 112 to control the pressure and temperature of the vapor 110 within the vapor chamber 112. In yet further aspects, the vapor chamber 112 also includes at least one second heating element 106 and at least one second thermocouple 108 to control the temperature of the vapor 110 present in the chamber 112.

The vapor 110 is then released through a nozzle 116. The nozzle 116 is coupled to the vapor chamber 112 via a duct 120, which in aspects is flexible and directional. A pressure and temperature controller 118 may be coupled to either the nozzle 116 or the duct 120 to regulate the temperature and pressure of the vapor 110. In addition to, or alternatively to, the pressure and temperature controller 118, a flow controller, such as a volume flow controller or a valve may be used. In aspects, the duct 120 and nozzle 116 direction may be altered to control the direction of vapor 110 flow towards the 3D printed component 124. In further aspects, mechanical linkages and motors may be coupled to the duct 120 and nozzle 116 to assist in redirecting the duct 120 and nozzle 116. While a single nozzle 116 and duct 120 are illustrated, multiple nozzles 116 and ducts 120 may be used. In aspects, the nozzle 116 is connected to or inserted within a channel 4 defined in the 3D printed component 124. In alternative or additional aspects, the nozzle 116 is directed at the 3D printed component 124. The vapor 110, directed via the one or more ducts 120 and nozzles 116 towards the 3D printed component 124, closes out the gaps (see 16, 17 of FIG. 1C) created by the extrusion-based system additive manufacturing process. In aspects, the nozzle 116 may be replaced with a sprinkler type head, depending upon the application.

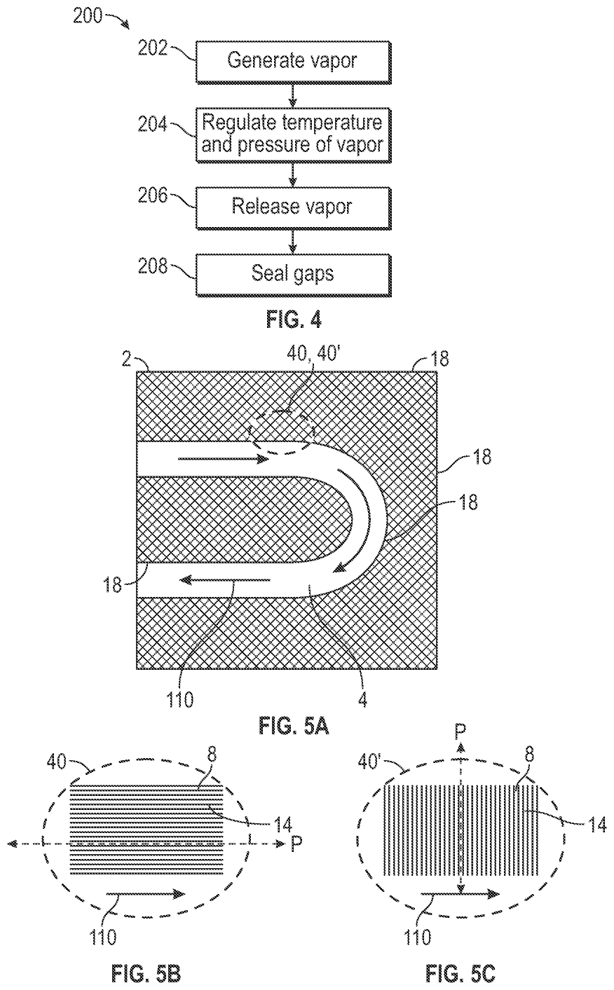

Turning to FIG. 4 and with further references to FIGS. 1A through 3, in various aspects a method of sealing the gaps 16, 17 is also contemplated. The method 200 begins with generating a vapor at block 202, such as water vapor. In aspects, this includes heating liquid 104, including one or more of the liquids noted above, in a heating chamber 102 to achieve a vapor state, such as steam in the case of water. At block 204, the vapor 110 is then conveyed to a vapor chamber 112 where the temperature and pressure are regulated or further adjusted based on the requirements of the material used for the extrudate 8. At block 206, the vapor 110 is then released at a flow rate and direction to fill the gaps 16, 17 in the 3D printed component 2, and in particular aspects the gaps 16, 17 formed in exposed surfaces 18 of the 3D printed component 2. The flow characteristics of the vapor 110 (laminar or turbulent flow) and vapor state (temperature and pressure) are also adjusted depending on the extrudate 8 material. At block 208 the vapor 110 then causes the outer portion 32 of the extrudate 8 to soften and become a semi-flowable surface and further forces the extrudate 8 in the layers 14 to flow together, sealing the gaps 16, 17 at the exposed surfaces 18 of the 3D printed component 2.

The vapor 110 may be directed to flow either with the extrudate 8 layers 14, at an angle to the extrudate 8 layers 14, or against and the extrudate 8 layers 14. Reference is made to FIGS. 5A through 5C, which illustrate an example of a channel 4 in a 3D printed component 2 through which vapor 110 may be directed (represented by the arrows). FIG. 5B illustrates an example where the vapor 110 flows parallel to the extrudate 8 layers 14. The vapor 110 may be adjusted such that the vapor 110 exhibits swirling or turbulent flow. Swirling or turbulent flow may be induced and facilitated by nozzle 116 design as well as process parameter selection. In addition, or alternatively, the 3D printed component 2 may be rotated and sealing of the gaps 16, 17 with vapor 110 may be facilitated by the rotation. Gravity may also be used to direct the steam to seal the gaps 16, 17. FIG. 5C illustrates an example where the vapor 110 flows perpendicular to the extrudate 8′ layers 14′. In such an embodiment, laminar or turbulent flow, which includes swirling flow, could be used seal the gaps 16, 17 as it pushes and drags the softened, semi flowable material into the gaps 16, 17. Again, a number of parameters are understood to affect the sealing process, including the compatibility of a temperature range and pressure range of the vapor with the extrudate material, flow direction, flow parameters like flow rate, flow motion, vapor and the involved materials convective and conductive coefficient in the working conditions. It is further noted that once gaps 16, 17 at the exposed surfaces 18 are sealed, gaps 20, 21 located within the infill of the wall sections 10 will not be exposed to the vapor. There are aspects, where gaps 20, 21 located within the infill may be sealed, particularly gaps 20, 21 that are relatively close to exposed surfaces 18 and exposed to the vapor 110 prior to the sealing of gaps 16, 17 at the exposed surfaces 18.

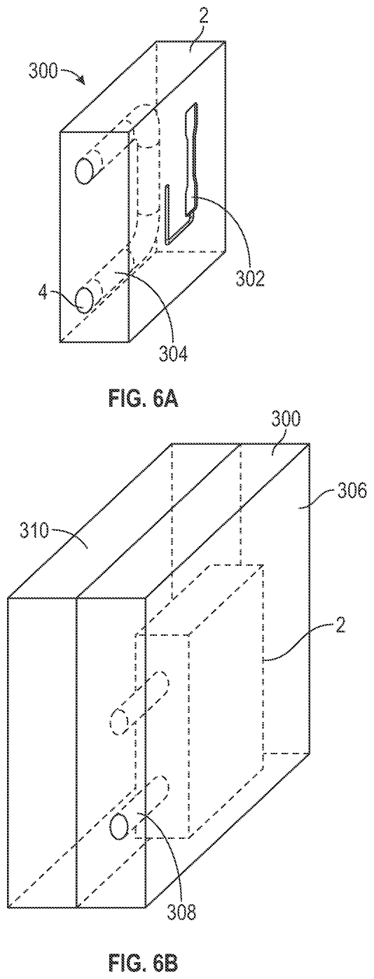

As alluded to above, in aspects, the 3D printed component 2 is a tool 300, or a portion of a tool 300 used for molding parts. FIG. 6A illustrates a tool 300 including the 3D printed component 2, which defines a molding cavity 302 and a plurality of channels 4, which, in aspects, define cooling lines 304 for circulating coolant through the tool 300. Alternatively, or additionally, the channels 4 may define, e.g., air lines, vacuum lines, ejector pin channels, or hydraulic lines. The 3D printed component 2 is formed by 3D printing as described above and at least a portion of the channels 4, such as those used for cooling lines 304, or as flow paths for other fluids or gasses, are sealed according to the methods of sealing gaps in a 3D printed component as described above, with reference to FIG. 4. FIG. 6B illustrates an aspect where the 3D printed component 2 of FIG. 6A is connected to a plate 306 and retained within an opening 312 in the plate 306. As illustrated, through bores 308 are provided in the plate 306 to provide access to the cooling lines 304 (illustrated in FIG. 6A). Alternative arrangements are also contemplated, wherein for example, the 3D printed component 2 is the plate 306, which is coupled to a second plate 310. Parts are then formed from the 3D printed component 2 using a variety of molding processes, such as injection molding, blow-molding, compression molding, roto-molding, composite lay-up, extrusion, vacuum forming, hydroforming, and casting.

Accordingly, a method of forming a tool 300 is also disclosed herein, wherein the component 2 provides at least a portion of the tool 300 (see FIG. 3B), and in aspects, the entire tool 300 (see FIG. 3A). The method includes forming a 3D printed component 2 by an additive manufacturing process such as fused filament fabrication, sealing the channels 4 that are used to convey liquids or gasses, such as cooling lines 304, air lines or hydraulic lines, and optionally sealing other exposed surfaces of the component 2. The component 2, in aspects, is then used as the tool 300 or, in alternative aspects, is assembled to provide at least a portion of a tool 300 by connecting the component 2 to one or more support plates 306, 310. The one or more support plates 306, 310 provide at least a portion of or, in aspects, the entire tool base. Prior to molding, the tool 300 is then set up in a molding machine and any cooling lines, air lines, hydraulic lines are coupled to the tool 300.

It is contemplated that an apparatus and process according to the present disclosure seals the gaps in 3D printed components of the present disclosure offers several advantages. These include the sealing of gaps, including openings and pores of various sizes, which in turn may lead to the provision of water-tight or air-tight, 3D printed components.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of sealing gaps in a component, comprising:
generating vapor from a liquid;
directing the vapor to an exposed surface of a component, wherein the component includes a plurality of layers of an extrudate and gaps between the plurality of layers and wherein the extrudate includes an outer portion;
softening the outer portion of the extrudate at the exposed surface; and
filling the gaps with the softened outer portion of the extrudate.

2. The method of claim 1, wherein the exposed surface is a channel defined within the component.

3. The method of claim 2, wherein the component is a tool and the channel is a cooling line.

4. The method of claim 1, wherein the extrudate has a glass transition temperature and the method further comprises adjusting at least one of a vapor temperature and vapor pressure to raise the outer portion of the extrudate to a temperature greater than the glass transition temperature of the extrudate.

5. The method of claim 4, wherein the extrudate includes an outer surface and the outer portion is up to 10% of a thickness of the extrudate from the outer surface.

6. The method of claim 5, wherein the outer portion of the extrudate includes a sheath having a lower glass transition temperature than a glass transition temperature of a core of the extrudate surrounded by the sheath.

7. The method of claim 1, wherein directing the vapor comprises inducing a laminate flow.

8. The method of claim 1, wherein directing the vapor comprises inducing a swirling or turbulent flow.

9. The method of claim 8, wherein the liquid is a weak acid.

10. The method of claim 8, wherein the liquid is an organic alcohol.

11. The method of claim 1, wherein the liquid is water.

12. An apparatus for sealing gaps in a 3D component, comprising:
a heating chamber including at least one first heating element;
a vapor chamber coupled to the heating chamber;
a pressure regulator operatively coupled to the vapor chamber; and
a nozzle coupled to the vapor chamber by a duct.

13. The apparatus of claim 12, further comprising at least one thermocouple operatively coupled to the heating chamber.

14. The apparatus of claim 12, wherein the vapor chamber includes at least one second heating element.

15. The apparatus of claim 12, further comprising at least one second thermocouple associated with the vapor chamber.

16. The apparatus of claim 12, wherein the at least one first heating element is located within the heating chamber.

17. The apparatus of claim 12, further comprising a bladder located in the vapor chamber.

18. The apparatus of claim 12, further comprising a plurality of nozzles.

19. A tool, comprising:
a component including an extrudate arranged in layers, wherein the component includes exposed surfaces;
a cavity defined by a first exposed surface;
a cooling line defined by a second exposed surface; and
a plurality of gaps between the layers, wherein the gaps between the layers at the second exposed surface are sealed with a portion of the extrudate.

20. A method of making a tool, comprising:
connecting a component to one or more support plates, the component including
an extrudate arranged in layers, wherein the component includes exposed surfaces,
a cavity defined by a first exposed surface,
a cooling line defined by a second exposed surface, and
a plurality of gaps between the layers, wherein the gaps between the layers at the second exposed surface are sealed with a portion of the extrudate.
